(19) United States
(12) Patent Application Publication
(10) Pub. No.: US 2026/0219551 A1
(43) Pub. Date: Jul. 30, 2026

(54) PHOTOGRAPHIC LAMP LENS MODULE AND PHOTOGRAPHIC LAMP

(71) Applicant: SHENZHEN LEQI INNOVATION CO., LTD., Shenzhen City (CN)

(72) Inventors: XING YE, Shenzhen City (CN); FENG QIN, Shenzhen City (CN)

(73) Assignee: SHENZHEN LEQI INNOVATION CO., LTD., Shenzhen City (CN)

(21) Appl. No.: 19/574,337

(22) Filed: Mar. 21, 2026

Related U.S. Application Data
(63) Continuation of application No. PCT/CN2024/097503, filed on Jun. 5, 2024.

(30) Foreign Application Priority Data
Sep. 21, 2023 (CN) 202322583397.9

(51) Int. Cl. G03B 15/02

(52) U.S. Cl. CPC G03B 15/02

(57) ABSTRACT

The present invention provides a photographic lamp lens module and a photographic lamp. The photographic lamp lens module, comprises: a housing; a rotary barrel, rotatably disposed within the housing; a lens barrel, extending into the rotary barrel and connected to the rotary barrel through a helical guide structure, a lens being disposed within the lens barrel; and an adjustment member, disposed on an outer periphery of the rotary barrel and partially protruding from the housing, the adjustment member being connected to the rotary barrel through a transmission assembly. In the technical solutions of the present invention, the adjustment member drives the rotary barrel to rotate through the transmission assembly, and the rotary barrel drives the lens barrel to move through the helical guide structure, thereby causing the lens to move and achieve smoother and more labor-saving focusing.

### CROSS-REFERENCE TO RELATED APPLICATIONS

The present invention is a continuation of International Patent Application No. PCT/CN2024/097503 filed on June 5, 2024, which claims the priority of China patent Application No. 202322583397.9 filed on September 21, 2023, the entire contents of which are incorporated herein by reference.

### TECHNICAL FIELD

The present invention relates to the technical field of photographic equipment, and particularly relates to a photographic lamp lens module and a photographic lamp.

### BACKGROUND

A photographic lamp generally comprises a photographic lamp body and a photographic lamp lens. The photographic lamp lens is disposed at a front end of the photographic lamp body for focusing light emitted from the photographic lamp body.

Currently, focusing methods for photographic lamp lenses generally involve manually rotating a threaded housing in cooperation with other threaded structural members to drive the lens to move forward and backward, thereby achieving focusing. Such focusing methods utilizing threaded engagement to drive the lens are prone to causing operational sticking. Meanwhile, for high-power photographic lamps, the lens becomes relatively hot after prolonged use, and manual rotation of the lens housing for focusing may easily result in scalding, resulting in low safety.

### SUMMARY

The present invention provides a photographic lamp lens module, aiming to solve technical problems existing in focus adjustment of conventional photographic lamp lenses, such as operational sticking and overheating.

To achieve the above object, the present invention adopts the following technical solutions.

A photographic lamp lens module, comprises:

a housing;

a rotary barrel, rotatably disposed within the housing;

a lens barrel, extending into the rotary barrel and connected to the rotary barrel through a helical guide structure, a lens being disposed within the lens barrel; and

an adjustment member, disposed on an outer periphery of the rotary barrel and partially protruding from the housing, the adjustment member being connected to the rotary barrel through a transmission assembly.

In an embodiment, the helical guide structure comprises a guide groove and a guide member mated therewith, the guide groove being helically disposed about an axis of the rotary barrel;

the guide groove is disposed on an inner side wall of the rotary barrel, and the guide member is disposed on an outer peripheral wall of the lens barrel; or the guide groove is disposed on the outer peripheral wall of the lens barrel, and the guide member is disposed on the inner side wall of the rotary barrel.

In an embodiment, the transmission assembly comprises a driving member and a driven member connected thereto, the driving member is connected to the adjustment member, and the driven member is disposed on an outer periphery of the rotary barrel.

In an embodiment, the driving member comprises a bevel gear, the driven member comprises a gear ring meshing with the bevel gear, and the gear ring is circumferentially disposed about the outer periphery of the rotary barrel.

In an embodiment, the outer peripheral wall of the lens barrel is provided with at least one limiting member, the housing is provided with a retaining ring at one end along an axial direction of the lens barrel, and the retaining ring is configured to block the limiting member so as to limit movement of the lens barrel.

In an embodiment, the outer peripheral wall of the lens barrel is provided with at least one relief groove, the limiting member is disposed within the relief groove, and a height of the limiting member is not higher than a groove opening of the relief groove.

In an embodiment, an inner side wall of the lens barrel is provided with a thermal insulation layer; and/or

the lens barrel comprises a barrel body and a pressure cover, an end face of the barrel body is provided with a mounting seat for installing the lens, and the pressure cover is disposed at an end portion of the barrel body and pressing the lens against the mounting seat.

In an embodiment, the rotary barrel is provided with a plurality of heat dissipation holes, the plurality of heat dissipation holes being circumferentially spaced about the rotary barrel.

In an embodiment, the lens is a Fresnel lens.

A photographic lamp comprises a photographic lamp body and the photographic lamp lens module, the lens module being disposed on one side of a light emitting direction of the photographic lamp body.

A photographic lamp lens module, comprises:

a housing;

a rotary barrel rotatable about an axis thereof in the housing;

a lens barrel connected to the rotary barrel through a helical guide structure,

a lens disposed in the lens barrel; and

an adjustment member connected to the rotary barrel through a transmission assembly;

wherein the helical guide structure converts rotational movement of the rotary barrel about an axis of rotary barrel into translational movement of the lens barrel along the axis, and the transmission assembly converts rotation of the adjustment member into the rotational movement of the rotary barrel about the axis.

In an embodiment, the adjustment member is a knob rotatable about an axis perpendicular to the axis of the rotary barrel.

In an embodiment, the lens barrel is coaxially disposed in the rotary barrel, and the adjustment member is disposed on an outer periphery of the rotary barrel and partially protruding from the housing.

In an embodiment, comprises a driving member and a driven member connected thereto, the driving member is connected to the adjustment member, and the driven member is disposed on an outer periphery of the rotary barrel.

In an embodiment, the transmission assembly is a gear transmission structure.

In an embodiment, the transmission assembly comprises at least one of a bevel gear assembly, a rack-and-pinion structure, and a worm gear structure.

In an embodiment, the driving member comprises a bevel gear, the driven member comprises a gear ring meshing with the bevel gear, and the gear ring is circumferentially disposed about an outer periphery of the rotary barrel.

In an embodiment, the helical guide structure comprises a guide groove and a guide member mated therewith, the guide groove being helically disposed about an axis of the rotary barrel; one of the guide groove and the guide member is disposed on an inner side wall of the rotary barrel, and the other is disposed on an outer peripheral wall of the lens barrel.

In an embodiment, the rotary barrel is provided with a plurality of heat dissipation holes circumferentially spaced about the rotary barrel; and/or the lens barrel is provided with a thermal insulation layer on an inner side wall thereof.

In an embodiment, the lens barrel is provided with at least one limiting member on an outer peripheral wall thereof, the housing is provided with a retaining ring at one end along an axial direction of the lens barrel, and the retaining ring is configured to abuts against the at least one limiting member so as to restrict continued movement of the lens barrel along the axial direction of the lens barrel.

In the technical solutions of the present invention, the adjustment member drives the rotary barrel to rotate through the transmission assembly, and the rotary barrel drives the lens barrel to move through the helical guide structure, thereby causing the lens to move and achieve focusing. Compared with the focusing method in the prior art of directly manually rotating a threaded housing, the present invention adopts a manner in which the adjustment member drives the lens barrel to move, providing smoother and more labor-saving focusing. Meanwhile, since the adjustment member partially protrudes from the housing, the hand will not directly contact the housing during focusing, preventing scalding and improving safety.

### BRIEF DESCRIPTION OF THE DRAWINGS

FIG. 1 is a schematic view of a photographic lamp lens module in accordance with an embodiment of the present invention;

FIG. 2 is an exploded perspective view of the photographic lamp lens module of FIG. 1 with a portion of the housing removed;

FIG. 3 is a schematic view of a rotary barrel in accordance with an embodiment of the present invention;

FIG. 4 is an exploded view of a lens barrel and lens in accordance with an embodiment of the present invention.

### Reference numerals:

1: housing

2: rotary barrel

3: lens barrel

4: lens

5: adjustment member

6: thermal insulation layer

10: helical guide structure

11: retaining ring

20: transmission assembly

21: heat dissipation hole

31: barrel body

32: pressure cover

101: guide groove

102: guide member

201: driving member

202: driven member

311: limiting member

312: relief groove

313: mounting seat

### DESCRIPTION OF THE EMBODIMENTS

In the present invention, the terms "disposed," "provided with," and "connected" should be understood in a broad sense. For example, they may be fixed connections, detachable connections, or unitary constructions; mechanical connections, or electrical connections; direct connections, or indirect connections through an intermediate medium. Those of ordinary skill in the art may understand the specific meanings of the above terms in the present invention according to specific circumstances.

The terms "center," "longitudinal," "lateral," "length," "width," "thickness," "upper," "lower," "front," "rear," "left," "right," "vertical," "horizontal," "top," "bottom," "inner," "outer," "clockwise," "counter-clockwise," "axial," "radial," "circumferential," and the like indicating orientations or positional relationships are based on the orientations or positional relationships shown in the drawings, and are merely for convenience in describing the present application and simplifying the description, rather than indicating or implying that the referred device or element must have a particular orientation, or be constructed and operated in a particular orientation. Therefore, they cannot be understood as limitations on the present application.

Furthermore, the terms "first" and "second" are used for descriptive purposes only and should not be understood as indicating or implying relative importance or implicitly indicating the number of indicated technical features. Thus, features defined with "first" and "second" may explicitly or implicitly include at least one such feature. In the description of the present application, the meaning of "a plurality of" is at least two, for example, two, three, etc., unless otherwise specifically defined.

Moreover, in addition to being used for indicating orientations or positional relationships, some of the above terms may also be used for indicating other meanings. For example, the term "upper" may in some cases also be used for indicating a certain dependent or connected relationship. Those of ordinary skill in the art may understand the specific meanings of these terms in the present invention according to specific circumstances.

In order to make the objects, technical solutions, and advantages of the present invention more clearly understood, the present invention will be further described in detail below with reference to the accompanying drawings and embodiments. It should be understood that the specific embodiments described herein are merely for explaining the present invention and are not intended to limit the present invention.

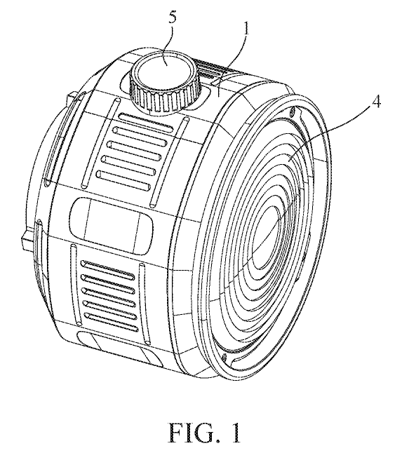

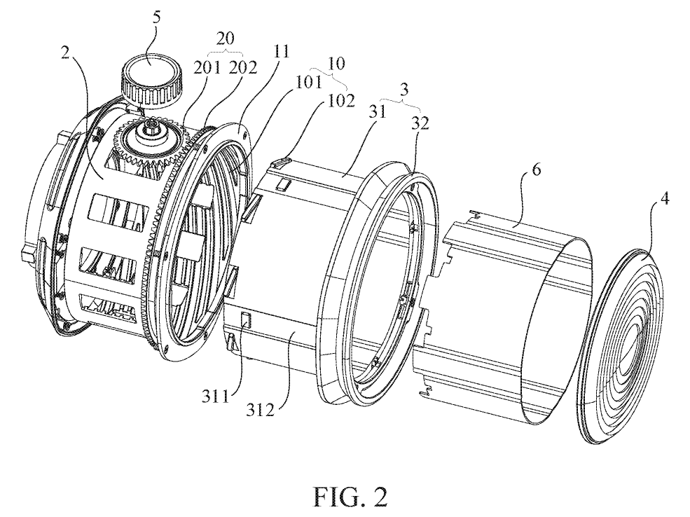

Referring to FIG. 1 and FIG. 2, the photographic lamp lens module proposed in this embodiment comprises:

a housing 1;

a rotary barrel 2 rotatably disposed within the housing 1;

a lens barrel 3 extending into the rotary barrel 2 and connected to the rotary barrel 2 through a helical guide structure 10, a lens 4 being disposed within the lens barrel 3; and

an adjustment member 5 disposed on an outer periphery of the rotary barrel 2 and partially protruding from the housing 1, the adjustment member 5 being connected to the rotary barrel 2 through a transmission assembly 20.

The photographic lamp lens module of this embodiment is applied to a photographic lamp. In this embodiment, the housing 1 is configured in a cylindrical shape, being hollow internally with open ends at both sides, and the interior of the housing 1 is used for installing the rotary barrel 2. Specifically, the rotary barrel 2 is rotatably disposed within the housing 1 and is rotatable relative to the housing 1. The rotary barrel 2 is configured to be hollow internally, and the lens barrel 3 extends into an interior of the rotary barrel 2. Optionally, the lens barrel 3 comprises a barrel body 31 and a pressure cover 32; the lens 4 is disposed at an end portion of the barrel body 31 and located between the barrel body 31 and the pressure cover 32, the barrel body 31 extends into the interior of the rotary barrel 2; and the lens 4 and the pressure cover 32 is exposed from the rotary barrel 2. The lens barrel 3 is movable relative to the rotary barrel 2 in an axial direction. Specifically, the lens barrel 3 is connected to the rotary barrel 2 through the helical guide structure 10. The lens barrel 3 is coaxially disposed in the rotary barrel 2, and the helical guide structure 10 converts rotational movement of the rotary barrel 2 about an axis of rotary barrel 2 into translational movement of the lens barrel 3 along the axis. When the rotary barrel 2 rotates, it drives the lens barrel 3 to move through the helical guide structure 10, thereby driving the lens 4 to move forward and backward to achieve focusing.

The adjustment member 5 in this embodiment is used for driving the rotary barrel 2 to rotate. Specifically, the adjustment member 5 is disposed on an outer periphery of the rotary barrel 2 and connected to the rotary barrel 2 through the transmission assembly 20. The transmission assembly 20 may be a gear transmission structure, such as a bevel gear assembly, a rack-and-pinion structure, a worm gear structure, or the like. Optionally, the adjustment member 5 is a knob, and more specifically a knob rotatable about an axis perpendicular to the axis of the rotary barrel 2. The transmission assembly 20 converts rotation of the adjustment member 5 into rotational movement of the rotary barrel 2 about the axis of the rotary barrel 2. Thus, by rotating the adjustment member 5, the adjustment member 5 drives the rotary barrel 2 to rotate through the transmission assembly 20, providing smooth and labor-saving transmission. Meanwhile, the adjustment member 5 partially protrudes from the housing 1, such that the adjustment member 5 is isolated from internal elements of the lens module, blocking heat transfer and preventing scalding during focusing.

When the lens module of this embodiment is applied to a photographic lamp focusing scenario, the adjustment member 5 is rotated, and the adjustment member 5 drives the rotary barrel 2 to rotate through the transmission assembly 20. The rotary barrel 2 drives the lens barrel 3 to move through the helical guide structure 10, thereby causing the lens 4 to move and achieve focusing. Compared with the focusing method in the prior art of directly manually rotating a threaded housing 1, the embodiment of the present invention adopts a manner in which the adjustment member 5 drives the lens barrel 3 to move, providing smoother and more labor-saving focusing. Meanwhile, since the adjustment member 5 partially protrudes from the housing 1, the hand will not directly contact the housing 1 during focusing, preventing scalding and improving safety.

Referring to FIG. 2, in some embodiments, the helical guide structure 10 comprises a guide groove 101 and a guide member 102 mated therewith, and the guide groove 101 is helically disposed about the axis of the rotary barrel 2.

The guide groove 101 is disposed on an inner side wall of the rotary barrel 2, and the guide member 102 is disposed on an outer peripheral wall of the lens barrel 3. Alternatively, the guide groove 101 is disposed on the outer peripheral wall of the lens barrel 3, and the guide member 102 is disposed on the inner side wall of the rotary barrel 2.

In this embodiment, the rotary barrel 2 and the lens barrel 3 are connected through the helical guide structure 10. The helical guide structure 10 comprises the guide groove 101 and the guide member 102. The guide member 102 mates with the guide groove 101, and the guide member 102 is receivable within the guide groove 101 and movable along the guide groove 101, thereby achieving relative movement between the lens barrel 3 and the rotary barrel 2. The guide groove 101 is a helical groove helically disposed about the axis of the rotary barrel 2, and the guide member 102 is a protrusion mating with the helical groove. In one embodiment, the guide groove 101 is disposed on the inner side wall of the rotary barrel 2, being spirally arranged about the inner side wall of the rotary barrel 2; and a plurality of guide members 102 are provided, being spaced on the outer peripheral wall of the lens barrel 3. Each guide member 102 is received within the guide groove 101. Thus, when the rotary barrel 2 rotates, the plurality of guide members 102 move along the guide groove 101, causing the lens barrel 3 to move relative to the rotary barrel 2, thereby achieving focusing. In another embodiment, the plurality of guide members 102 are disposed on the inner side wall of the rotary barrel 2, and the guide groove 101 is disposed on the outer peripheral wall of the lens barrel 3, being helically disposed about the outer peripheral wall of the lens barrel 3. Each guide member 102 is received within the guide groove 101. Thus, when the rotary barrel 2 rotates, the plurality of guide members 102 move along the guide groove 101, pushing the lens barrel 3 to move relative to the rotary barrel 2, thereby achieving focusing.

Referring to FIG. 2, in some embodiments, the transmission assembly 20 comprises a driving member 201 and a driven member 202 connected thereto. The driving member 201 is connected to the adjustment member 5, and the driven member 202 is disposed on an outer periphery of the rotary barrel 2. Optionally, the driving member 201 comprises a bevel gear, the driven member 202 comprises a gear ring meshing with the bevel gear, and the gear ring is circumferentially disposed about the outer periphery of the rotary barrel 2.

In this embodiment, the adjustment member 5 drives the rotary barrel 2 to rotate through the transmission assembly 20, the adjustment member 5 is configured as a knob structure, and the transmission assembly 20 is configured as a gear transmission structure. Specifically, the transmission assembly 20 comprises the driving member 201 and the driven member 202, the driving member 201 comprises a bevel gear, and the driven member 202 comprises a gear ring disposed on the outer periphery of the rotary barrel 2. The bevel gear has a connecting shaft and a gear portion, the connecting shaft of the bevel gear is connected to the adjustment member 5, and the gear portion of the bevel gear meshes with the gear ring on the outer periphery of the rotary barrel 2. The diameter of the bevel gear is smaller than that of the gear ring. Thus, upon rotation of the adjustment member 5, the bevel gear rotates, and drives the gear ring to rotate through gear meshing transmission, thereby driving the rotary barrel 2 to rotate. The present embodiment employs gear transmission, providing smoother and more precise transmission, more labor-saving focusing, and improved user experience.

Referring to FIG. 2, in some embodiments, the outer peripheral wall of the lens barrel 3 is provided with at least one limiting member 311, the housing 1 is provided with a retaining ring 11 at one end along an axial direction of the lens barrel 3, and the retaining ring 11 is configured to block the limiting member 311 so as to limit movement of the lens barrel 3.

In this embodiment, the retaining ring 11 on the housing 1 is used to block the limiting member 311, so as to limit a travel stroke of the lens barrel 3 within the rotary barrel 2 and prevent the lens barrel 3 from disengaging from the rotary barrel 2. Specifically, at least one limiting member 311 is provided, the limiting member 311 being a protrusion disposed on the outer peripheral wall of the lens barrel 3. When a plurality of limiting members 311 are provided, the plurality of limiting members 311 are circumferentially spaced about the lens barrel 3. The retaining ring 11 is a portion of the housing 1, being disposed at an end portion of the rotary barrel 2. When the lens barrel 3 moves to a maximum focal length position during a focusing process, the limiting member 311 on the lens barrel 3 contacts the retaining ring 11, thereby limiting continued movement of the lens barrel 3 and preventing the lens barrel 3 from disengaging from the rotary barrel 2.

Optionally, the outer peripheral wall of the lens barrel 3 is provided with at least one relief groove 312, the limiting member 311 is disposed within the relief groove 312, and a height of the limiting member 311 is not higher than a groove opening of the relief groove 312.

In this embodiment, the relief groove 312 on the outer peripheral wall of the lens barrel 3 is used to accommodate the limiting member 311 and prevent interference between the limiting member 311 and the rotary barrel 2. Specifically, at least one relief groove 312 is provided, formed on the outer peripheral wall of the lens barrel 3, and the relief groove 312 is a strip-shaped groove extending along an axial direction of the lens barrel 3. When a plurality of relief grooves 312 are provided, the plurality of relief grooves 312 are circumferentially spaced about the lens barrel 3, one relief groove 312 correspondingly accommodating one limiting member 311. In this embodiment, the height of the limiting member 311 is not higher than the groove opening of the relief groove 312, that is to say, it is to be understood that the limiting member 311 does not protrude from the outer peripheral wall of the lens barrel 3, thereby avoiding interference between the limiting member 311 and the rotary barrel 2.

Referring to FIG. 2, in some embodiments, the inner side wall of the lens barrel 3 is provided with a thermal insulation layer 6. The thermal insulation layer 6 in this embodiment is used to block heat emitted from the photographic lamp, further avoiding scalding. In this embodiment, the thermal insulation layer 6 is disposed on the inner side wall of the lens barrel 3, blocking heat transfer to the lens barrel 3, the rotary barrel 2, and the housing 1, thereby greatly reducing the risk of scalding and enhancing user experience. The thermal insulation layer 6 may be made of materials having low thermal conductivity, such as silicone or ceramic.

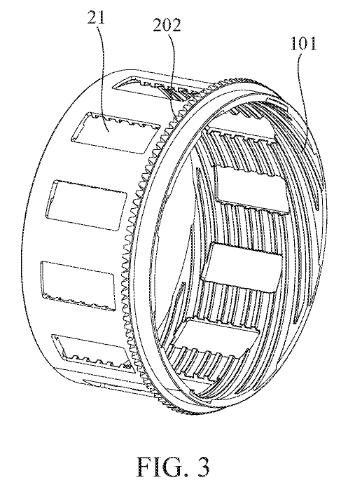

Referring to FIG. 3, in some embodiments, the rotary barrel 2 is provided with a plurality of heat dissipation holes 21, and the plurality of heat dissipation holes 21 is circumferentially spaced about the rotary barrel 2. In this embodiment, the heat dissipation holes 21 are used to dissipate heat emitted from the photographic lamp. Specifically, a plurality of heat dissipation holes 21 are provided and circumferentially spaced about the rotary barrel 2. By providing the plurality of heat dissipation holes 21, heat dissipation area and heat dissipation channels are increased, improving heat dissipation performance of the lens module and further reducing the risk of scalding.

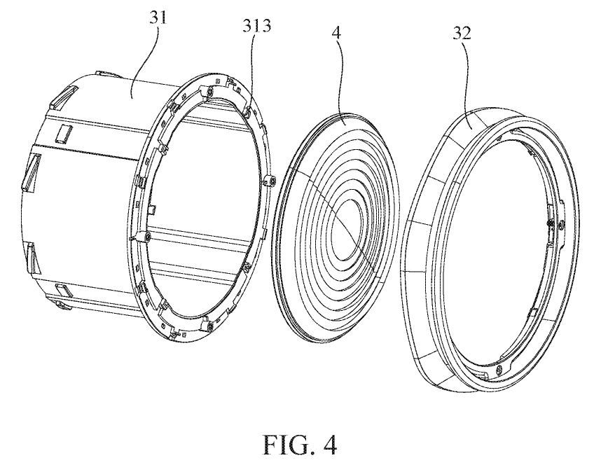

Referring to FIG. 4, in some embodiments, the lens barrel 3 comprises a barrel body 31 and a pressure cover 32, an end face of the barrel body 31 is provided with a mounting seat 313 for installing the lens 4, and the pressure cover 32 is disposed at an end portion of the barrel body 31, pressing the lens 4 against the mounting seat 313.

In this embodiment, the lens 4 is installed between the end portion of the barrel body 31 and the pressure cover 32 through the mounting seat 313. Specifically, the mounting seat 313 comprises a plurality of steps circumferentially spaced on the end face of the barrel body 31, the lens 4 is supported on the plurality of steps, and the pressure cover 32 presses toward the lens 4, thereby securing the lens 4 to the end portion of the barrel body 31. Optionally, the pressure cover 32 and the barrel body 31 are fastened by screws.

Optionally, the lens 4 is a Fresnel lens. The Fresnel lens is relatively thin, such that the lens module has a compact and lightweight structure, improving portability of the photographic lamp.

Optionally, the lens 4 is a Fresnel convex lens.

The present invention further provides a photographic lamp, the photographic lamp comprising a photographic lamp body and the photographic lamp lens module as described in the above embodiments. The lens module is disposed on one side of the photographic lamp body in a light emitting direction.

For the specific structure of the photographic lamp lens module, reference is made to the above embodiments. Since the present photographic lamp employs technical solutions of the above embodiments, it has at least all technical effects brought by the technical solutions of the above embodiments, which will not be reiterated herein one by one.

The foregoing descriptions are merely specific embodiments of the present application. It should be pointed out that, for those of ordinary skill in the relevant technical field, various improvements and modifications may be made without departing from the principles of the present application, and such improvements and modifications should also be regarded as falling within the protection scope of the present application.

What is claimed is:

1. A photographic lamp lens module, comprising:
a housing;
a rotary barrel, rotatably disposed within the housing;
a lens barrel, extending into the rotary barrel and connected to the rotary barrel through a helical guide structure, a lens being disposed within the lens barrel; and
an adjustment member, disposed on an outer periphery of the rotary barrel and partially protruding from the housing, the adjustment member being connected to the rotary barrel through a transmission assembly.

2. The photographic lamp lens module according to claim 1 wherein the helical guide structure comprises a guide groove and a guide member mated therewith, the guide groove being helically disposed about an axis of the rotary barrel;
the guide groove is disposed on an inner side wall of the rotary barrel, and the guide member is disposed on an outer peripheral wall of the lens barrel; or the guide groove is disposed on the outer peripheral wall of the lens barrel, and the guide member is disposed on the inner side wall of the rotary barrel.

3. The photographic lamp lens module according to claim 1 wherein the transmission assembly comprises a driving member and a driven member connected thereto, the driving member is connected to the adjustment member, and the driven member is disposed on an outer periphery of the rotary barrel.

4. The photographic lamp lens module according to claim 3 wherein the driving member comprises a bevel gear, the driven member comprises a gear ring meshing with the bevel gear, and the gear ring is circumferentially disposed about the outer periphery of the rotary barrel.

5. The photographic lamp lens module according to claim 1 wherein the outer peripheral wall of the lens barrel is provided with at least one limiting member, the housing is provided with a retaining ring at one end along an axial direction of the lens barrel, and the retaining ring is configured to block the limiting member so as to limit movement of the lens barrel.

6. The photographic lamp lens module according to claim 5 wherein the outer peripheral wall of the lens barrel is provided with at least one relief groove, the limiting member is disposed within the relief groove, and a height of the limiting member is not higher than a groove opening of the relief groove.

7. The photographic lamp lens module according to claim 1 wherein an inner side wall of the lens barrel is provided with a thermal insulation layer; and/or
the lens barrel comprises a barrel body and a pressure cover, an end face of the barrel body is provided with a mounting seat for installing the lens, and the pressure cover is disposed at an end portion of the barrel body and pressing the lens against the mounting seat.

8. The photographic lamp lens module according to claim 1 wherein the rotary barrel is provided with a plurality of heat dissipation holes, the plurality of heat dissipation holes being circumferentially spaced about the rotary barrel.

9. The photographic lamp lens module according to claim 1 wherein the lens is a Fresnel lens.

10. A photographic lamp, wherein the photographic lamp comprises a photographic lamp body and the photographic lamp lens module according to claim 1 the lens module being disposed on one side of a light emitting direction of the photographic lamp body.

11. A photographic lamp lens module, comprising:
a housing;
a rotary barrel rotatable about an axis thereof in the housing;
a lens barrel connected to the rotary barrel through a helical guide structure;
a lens disposed in the lens barrel; and
an adjustment member connected to the rotary barrel through a transmission assembly;
wherein the helical guide structure converts rotational movement of the rotary barrel about an axis of rotary barrel into translational movement of the lens barrel along the axis, and the transmission assembly converts rotation of the adjustment member into the rotational movement of the rotary barrel about the axis.

12. The photographic lamp lens module according to claim 11 wherein the adjustment member is a knob rotatable about an axis perpendicular to the axis of the rotary barrel.

13. The photographic lamp lens module according to claim 12 wherein the lens barrel is coaxially disposed in the rotary barrel, and the adjustment member is disposed on an outer periphery of the rotary barrel and partially protruding from the housing.

14. The photographic lamp lens module according to claim 11 wherein comprises a driving member and a driven member connected thereto, the driving member is connected to the adjustment member, and the driven member is disposed on an outer periphery of the rotary barrel.

15. The photographic lamp lens module according to claim 14 wherein the transmission assembly is a gear transmission structure.

16. The photographic lamp lens module according to claim 14 wherein the transmission assembly comprises at least one of a bevel gear assembly, a rack-and-pinion structure, and a worm gear structure.

17. The photographic lamp lens module according to claim 16 wherein the driving member comprises a bevel gear, the driven member comprises a gear ring meshing with the bevel gear, and the gear ring is circumferentially disposed about an outer periphery of the rotary barrel.

18. The photographic lamp lens module according to wherein the helical guide structure comprises a guide groove and a guide member mated therewith, the guide groove being helically disposed about an axis of the rotary barrel; one of the guide groove and the guide member is disposed on an inner side wall of the rotary barrel, and the other is disposed on an outer peripheral wall of the lens barrel.

19. The photographic lamp lens module according to claim 11 wherein the rotary barrel is provided with a plurality of heat dissipation holes circumferentially spaced about the rotary barrel; and/or the lens barrel is provided with a thermal insulation layer on an inner side wall thereof.

20. The photographic lamp lens module according to claim 11 wherein the lens barrel is provided with at least one limiting member on an outer peripheral wall thereof, the housing is provided with a retaining ring at one end along an axial direction of the lens barrel, and the retaining ring is configured to abuts against the at least one limiting member so as to restrict continued movement of the lens barrel along the axial direction of the lens barrel.
